(19) United States
(12) Patent Application Publication
(10) Pub. No.: US 2015/0059993 A1
(43) Pub. Date: Mar. 5, 2015

(54) WINDOW TREATMENT MOUNTING SYSTEM

(71) Applicant: Lutron Electroncs Co., Inc., Coopersburg, PA (US)

(72) Inventor: James J. Wilson, Nazareth, PA (US)

(21) Appl. No.: 14/015,009

(22) Filed: Aug. 30, 2013

(51) Int. Cl. E06B 9/42; E05D 15/16; E06B 9/56

(52) U.S. Cl. CPC E06B 9/42; E06B 9/56; E05D 15/16; E06B 2009/587
USPC 160/368.1; 29/428

(57) ABSTRACT

A window treatment system can be mounted to a plurality of vertical surfaces that separate adjacent windows from each other. The window treatment system can include at least two mounting clips, a window treatment housing and a window treatment assembly (e.g., a motorized roller shade assembly). The at least two mounting clips can be affixed to the plurality of vertical surfaces. As well, the window treatment housing can include a housing clip that is configured to mate with the at least two mounting clips. In this manner, the window treatment housing can be mounted to the plurality of vertical surfaces.

### BACKGROUND

Window treatment housings are typically mounted directly to a blocking that is adjacent a window frame. It is often desirable for the window treatment to be level for both aesthetic and functional reasons. However, blocking material may be difficult to install and may increase the materials and labor required in installing window treatments. Furthermore, because window treatment housings are directly mounted to the blocking, this may create difficulties in leveling because the installer is required to balance the entire housing while installing fasteners to couple the housing to the blocking.

Accordingly, it is desirable to remove blocking material from the system and also allow the installer to level the window treatment housing without having to balance the entire housing assembly during the installation process.

### SUMMARY

The present invention provides methods and systems for mounting window treatment systems to the surfaces surrounding a window pane, such as the mullions of a window.

In accordance with an embodiment, the disclosure includes a method of mounting a window treatment system. The method can includes affixing at least two mounting clips to respective vertical surfaces of a plurality of vertical surfaces. Each vertical surface can separate and support a respective pair of adjacent windows. The method can also include supporting a window treatment housing on the mounting clips. The window treatment housing can define an internal cavity sized and configured to retain a shade assembly having a covering material and a motor configured to move the covering material between a raised position and a lowered position. The method can also include affixing the window treatment housing to at least one vertical surface of the plurality of vertical surfaces with a fixation element.

In another embodiment, the disclosure provides another method of mounting a window treatment system. The method can include affixing at least two mounting clips to respective vertical surfaces of a plurality of vertical surfaces. Each vertical surface can separate a respective pair of adjacent windows from each other. As well, each mounting clip can include a support portion and a clip portion that extends out from the support portion. The method can also include supporting a window treatment housing from the clip portions of the mounting clips such that a back wall of the window treatment housing and the support portions are coplanar. The window treatment housing can define an internal cavity sized that can be configured to retain a shade assembly having a covering material and a motor configured to move the covering material between a raised position and a lowered position.

In accordance with another embodiment, a window treatment system can be configured to be mounted to a plurality of vertical surfaces that separate adjacent windows from each other. Each vertical surface can be elongate along a first direction. The window treatment system can include at least two mounting clips that can be configured to be mounted to at least two respective vertical surfaces of the plurality of vertical surfaces. Each mounting clip can include a support portion and a clip portion that extends out from the support portion. As well, each support portion can define a back surface.

The window treatment system can also include a window treatment housing that can be elongate along a second direction that is perpendicular to the first direction. The window treatment housing can include a back wall that defines a back surface and at least partially defines an internal cavity. The window treatment housing can further define at least one housing clip that is recessed relative to the back surface of the back wall along a third direction that is perpendicular to the first and second directions. The at least one housing clip can be configured to mate with the clip portions of the mounting clips to thereby mount the window treatment housing to the vertical surfaces such that the back surfaces of the support portions are coplanar with the back surface of the back wall.

The window treatment system can also include a shade assembly configured to be mounted to the window treatment housing within the internal cavity. The shade assembly can have a covering material and a motor configured to move the covering material between a raised position and a lowered position.

### BRIEF DESCRIPTION OF THE DRAWINGS

The foregoing summary, as well as the following detailed description of an example embodiment of the application, will be better understood when read in conjunction with the appended drawings, in which there is shown in the drawings example embodiments for the purposes of illustration. It should be understood, however, that the application is not limited to the precise arrangements and systems shown. In the drawings:

FIG. 1 is a simplified front view of a window treatment system having a plurality of roller shades in accordance with an embodiment, the window shade system is mounted adjacent a window having two window panes, the window shade system is mounted to the sides of the window and to a mullion between the two window panes;

FIG. 2A is a top perspective view of a portion of the window treatment system of FIG. 1 showing how the window treatment system is mounted to the mullion, which includes a pair of openings for receiving the two window panes, the window treatment system includes a mounting clip, a window shade housing mounted to the mullion via the mounting clip and a roller shade assembly that is mounted to the window shade housing within an internal cavity of the window shade housing;

FIG. 2B is a top plan view of the portion of the window treatment system attached to the mullion as shown in FIG. 2A;

FIG. 3 is a top perspective view of the portion of the window treatment system shown in FIG. 2A;

FIG. 4A is a side elevation view of the portion of the window treatment system as shown in FIG. 2A;

FIG. 4B is a detailed side view of the portion of the window treatment system as shown in FIG. 4A further illustrating the mating connections between the mounting clip and the window shade housing and between the motorized shade assembly and the window shade housing, the mounting clip including a support portion and a clip portion, the window shade housing including a housing clip that defines a recess that mates with the clip portion of the mounting clip, the window shade housing further including an internal mounting member that supports the roller shade assembly;

FIG. 4C is a side elevation view of the mounting clip shown in FIG. 4B;

FIG. 4D is a side elevation view of a back wall portion of the window treatment housing shown in FIG. 4B;

FIG. 5A is a front elevation view of the window treatment system as shown in FIG. 2A;

FIG. 5B is a detailed view of the mounting clip, further illustrating that the mounting clip includes a slot and a scribe line; and

FIG. 6 is a flow-chart illustrating a method of mounting a window treatment system in accordance with an embodiment.

### DETAILED DESCRIPTION OF ILLUSTRATIVE EMBODIMENTS

Certain terminology is used in the following description for convenience only and is not limiting. The words “right”, “left”, “lower”, “upper”, “top”, or “bottom” designate directions in the drawings to which reference is made. The words “proximally” and “distally” refer to directions toward and away from, respectively, the individual operating the system. The terminology includes the above-listed words, derivatives thereof and words of similar import.

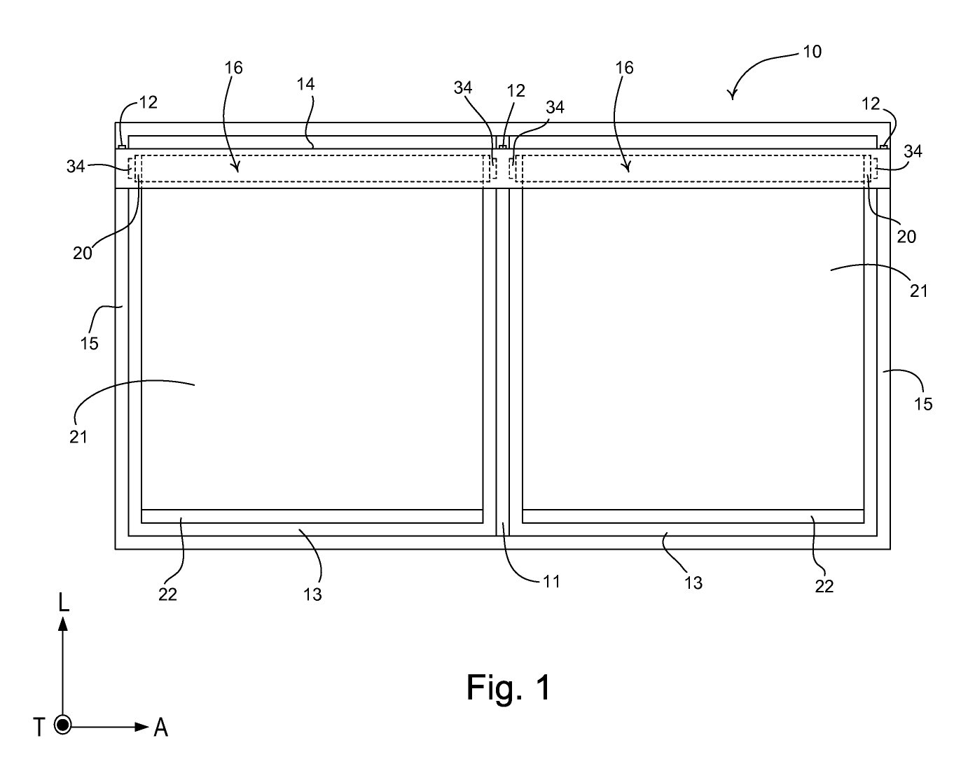

Referring to FIGS. 1, 2A-2B, and 3, a window treatment system 10 is configured to be mounted in front of a window having a plurality of window panes 13 (e.g., two window panes as shown in FIG. 1). The window panes 13 can be separated by one or more mullions 11 (e.g., one mullion as shown in FIG. 1). The window treatment system 10 may include, for example, one or more roller shade assemblies 16 (e.g., motorized roller shades). Each roller shade assembly 16 may comprise a covering material 21 that hangs in front of the respective window pane 13 and is wound around a roller tube 20, such that the covering material 21 extends from the roller tube 20 to a hembar 22 at a lower end. For example, each roller shade assembly 16 may include a motor drive unit or motor (not shown) located inside the roller tube 20 for rotating the roller tube 20 to raise and lower the covering material 21 between a raised position and a lowered position along the first direction L. The window treatment system 10 can include a window shade housing 14 (e.g. a window treatment housing, pocket, or fascia) in which the roller tubes 20 of the roller shade assemblies 16 are located. Each roller tube 20 is rotatably supported by two mounting brackets 34, which are configured to be supported by the window shade housing 14.

The window shade housing 14 is configured to be supported by one or more mounting clips 12, which may be affixed to the mullion 11, as well as a window frame 15, the building structure at sides of the window panes 13, or a vertical surface. The mounting clips 12 and the window shade housing 14 are configured such that when the window shade housing 14 is supported by the mounting clips 12, both the mounting clips 12 and the window shade housing 14 lie flush against the mullion 11, building structure, window frame surrounding the window, or any adjacent vertical surface. Further, the mounting clips 12 are configured to be mounted to the mullion 11, building structure, window frame, or vertical surface and leveled with respect to each other prior to the window shade housing 14 being mounted to the mounting clips 12. Thus, the window shade housing 14 can be more easily mounted adjacent a window or windows that are supported by mullions 11 as compared to known systems.

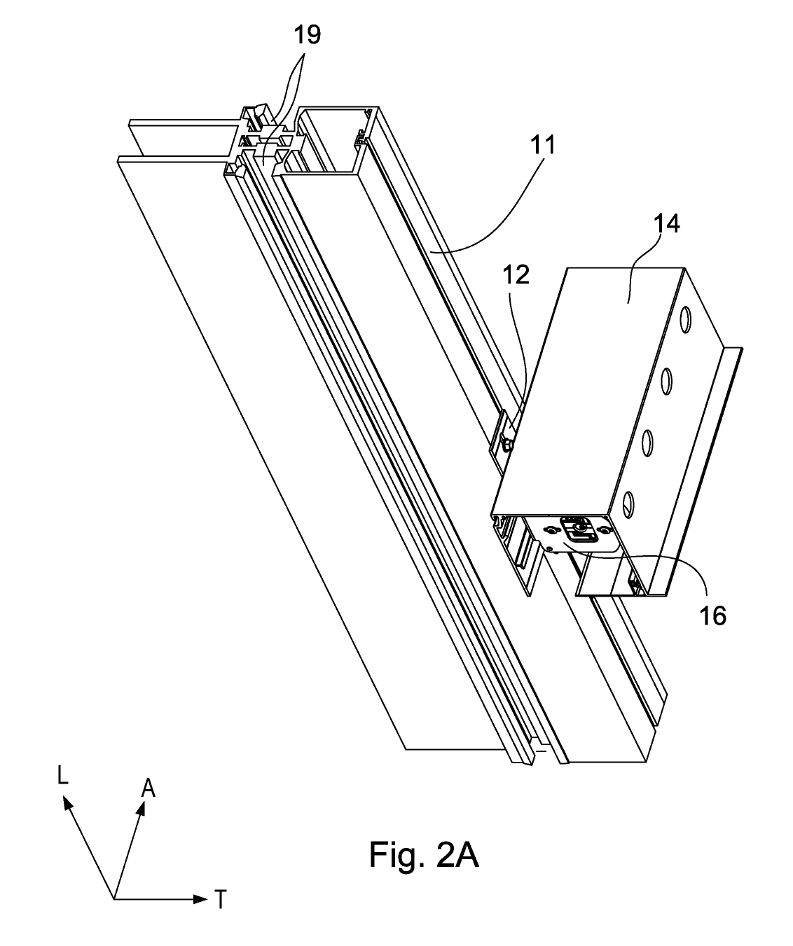

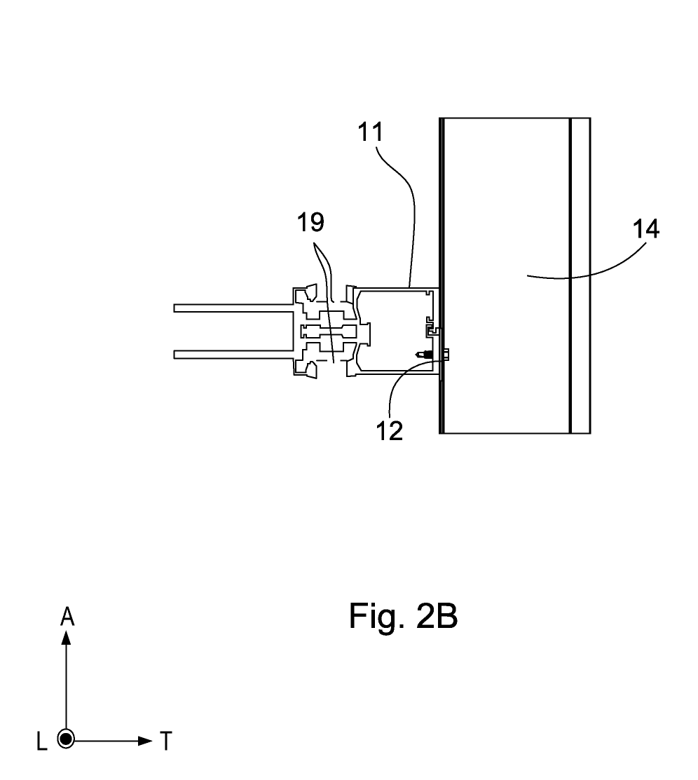

With continued reference to FIGS. 2A and 2B, each mullion 11 can define a portion of a window frame, whereby each respective mullion 11 is elongate along a first direction L. Each mullion 11 can define at least one opening 19 that can receive the respective window pane 13 such that each mullion 11 separates the adjacent window panes from each other along a second direction A that is perpendicular to the first direction L.

As shown in FIG. 1, the window treatment system 10 can be mounted to any structure as desired, for example, to the mullion 11 or other portions of the building structure, window frame, or any vertical surface as desired. For example, while the illustrated embodiments show the window treatment system 10 mounted to mullions 11, it should be appreciated that the window treatment system 10 can be mounted to any respective vertical surface of a plurality of vertical surfaces, whereby each vertical surface separates and supports a respective pair of adjacent windows. It should also be appreciated that a window frame can include an upper support member, a lower support member that are both elongate along the second direction A and spaced from each other along the first direction L, and a pair of mullions 11 that extend between the upper and lower support members so as to surround a perimeter of a window. The window treatment system 10 can be affixed to the upper support member as desired. It should also be appreciated that the upper and lower support members can be referred to as horizontal surfaces.

While the window shade housing 14 can span a plurality of mullions 11 and window panes 13, it should be appreciated, that at least two mullions 11 of the plurality of mullions 11 can have respective mounting clips 12 affixed to them. Therefore, mounting clips 12 can be affixed to at least two mullions 11 and up to all of the mullions 11 of the plurality of mullions 11 in which the window shade housing 14 spans. For example, the window shade housing 14 may be elongate across three mullions 11, while two mounting clips 12 may be affixed to a respective two mullions 11 of the three mullions 11. It should be appreciated, however, that the window shade housing 14 can span across any number of mullions 11 and any number of mounting clips 12 may be attached to any respective number of mullions 11. In this manner, the mounting clips 12 can be configured to be any suitable size or shape to affix any size window shade housing 14 and roller shade assembly 16 to any respective number of mullions 11.

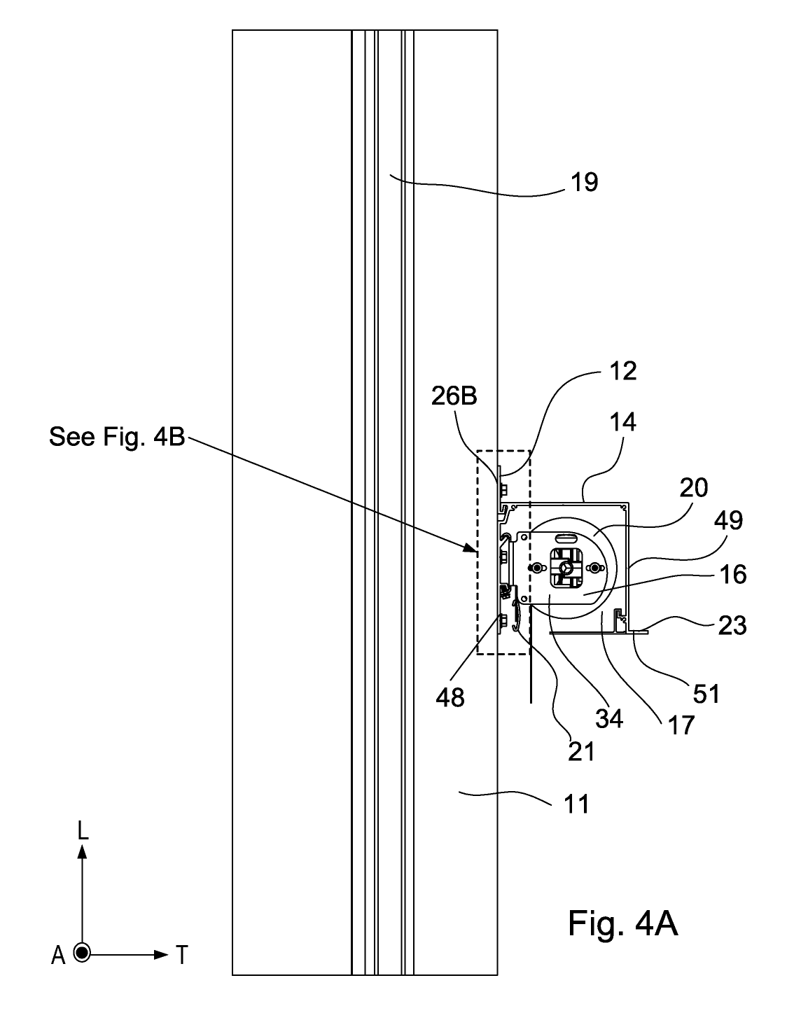

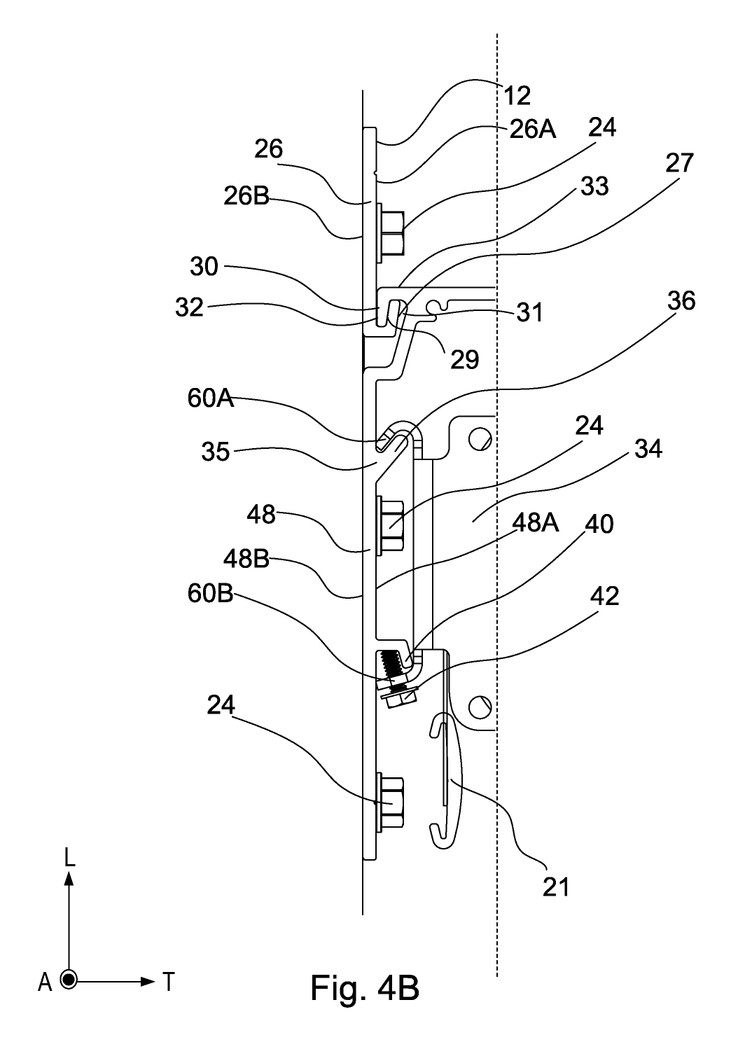

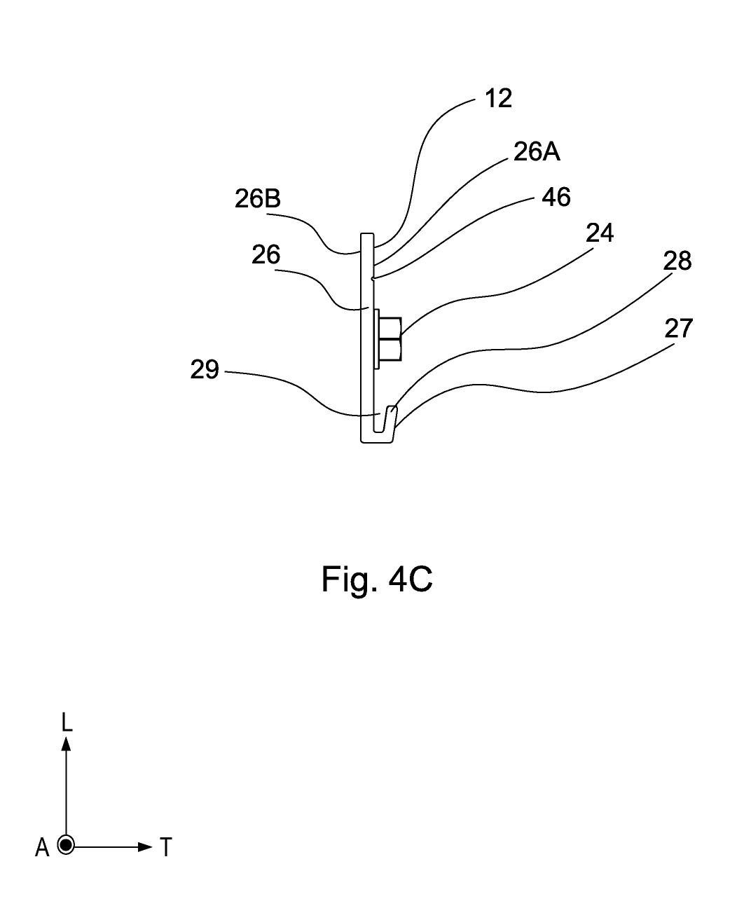

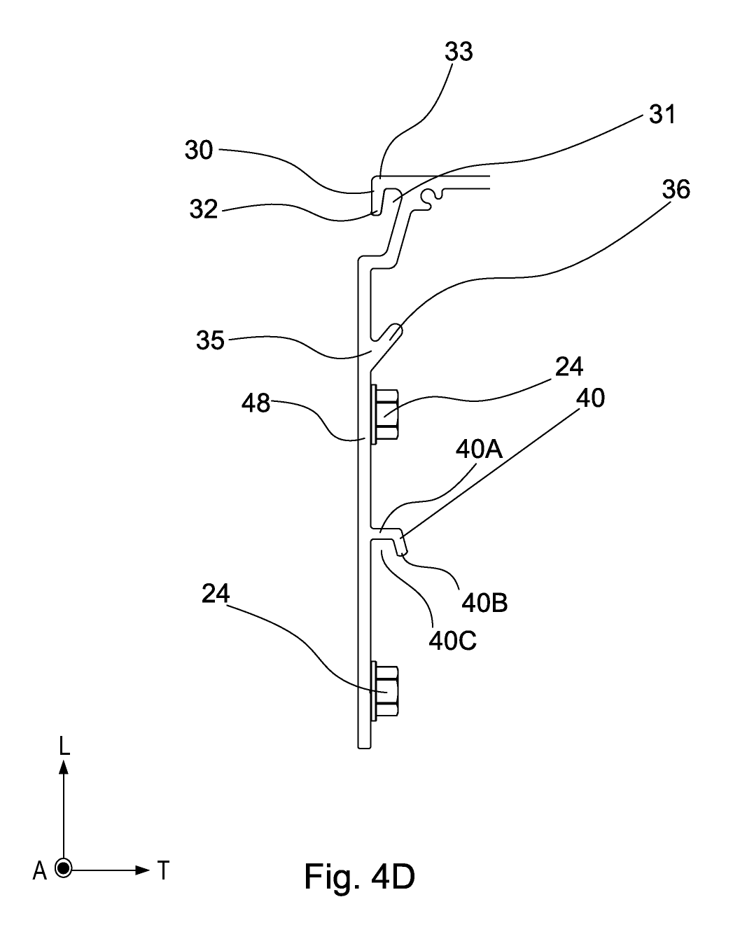

Now in reference to FIGS. 4A-4C, each mounting clip 12 includes a support portion 26 that is elongate along the first direction L and a clip portion 27 that extends out from the support portion 26 along a third direction T that is perpendicular to both the first and second directions L and A. As shown in FIG. 4A, the support portion 26 is configured to receive a fixation element 24 to thereby fixedly attach the mounting clip 12 to the mullion 11 (or building structure, window frame, or vertical surface). It should be appreciated that the fixation element 24 can be any type of screw, bolt, nail, or any type of fastening device that can affix the mounting clip 12 to the mullion 11. It should also be appreciated that the fixation element 24 can be any type of hook-and-loop fastening system, adhesive, mortar, or any type of material that is configured to bond a mounting clip 12 to a window frame. Yet it should further be appreciated that the mounting clip 12 can be made of a plastic, metal, or any other suitable material as desired.

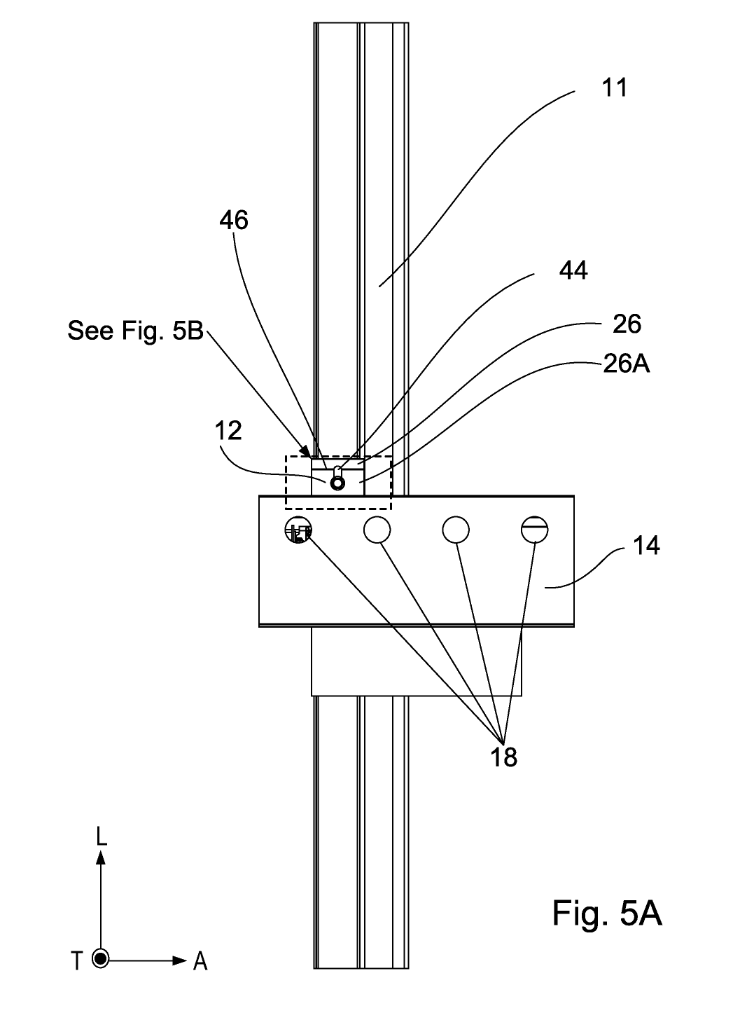

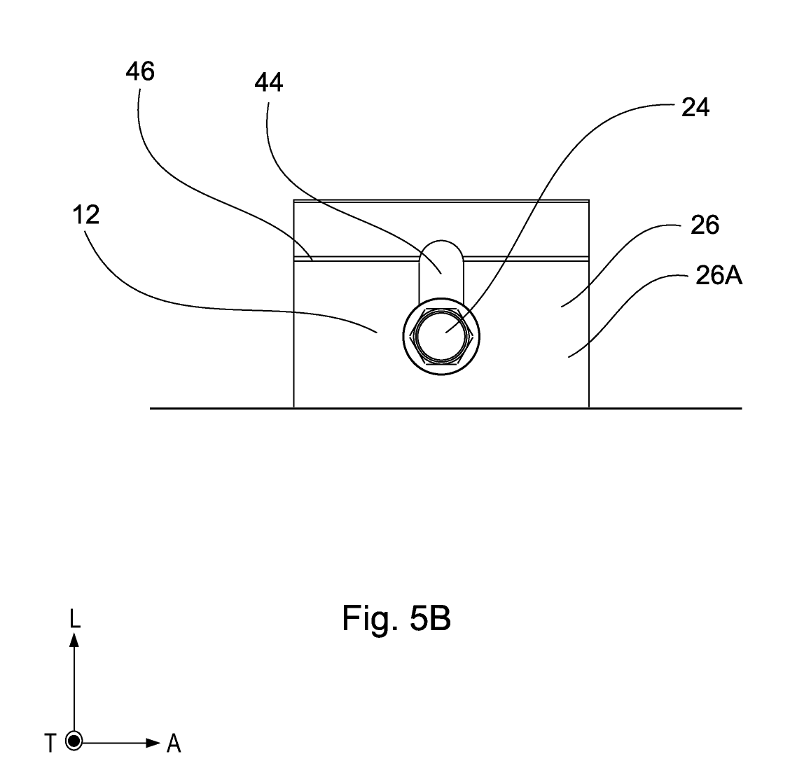

As shown in FIGS. 4C and 5A-5B, the support portion 26 of the mounting clip 12 can include a planar body defining a front surface 26A, a back surface 26B, and a slot 44 that extends through the body from the front surface 26A to the back surface 26B. The slot 44 can be elongate along the first direction L and can be configured to receive the respective fixation element 24 to thereby affix the mounting clip 12 to the mullion 11. The elongate slot 44 allows the mounting clip 12 to be temporarily loosely coupled to the respective mullion 11 such that the mounting clip 12 can be moved or otherwise adjusted with respect to the fixation element 24 along the first direction L prior to being fully tightened against the mullion 11. As shown in FIGS. 4C, 5A, and 5B, the mounting clip 12 can include a scribe line 46 that extends into the front surface 26A and along the front surface 26A along the second direction A. The scribe line 46 can be used to level the mounting clips 12 with respect to each other and/or another reference object such as the ceiling. For example, the mounting clips 12 may be mounted such that the scribe line 46 is located 6 inches (152.4 mm) above a surface of the finished ceiling height. It should be appreciated, however, that the mounting clips 12 may be mounted such that the scribe line 46 is located at any distance above or below the surface of the finished ceiling height as desired or some distance relative to any desired reference object. It should further be appreciated that the scribe line 46 may be positioned at any location on the mounting clip 12. For example, while the illustrated mounting clip 12 includes a scribe line 46 that extends across the entire front surface 26A of the support portion 26, in some embodiments the scribe line 46 can extend along a portion of the front surface 26A as desired.

Referring back to FIGS. 4A and 4B, the back surface 26B can be substantially planar such that when the mounting clip 12 is affixed to the mullion 11, the back surface 26B lies flush against the mullion 11. It should be appreciated that flush in this context means that at least a portion of the back surface 26B of the support portion 26 abuts a front surface of the respective mullion 11. It should be appreciated that a majority of the back surface 26B such as the entire back surface 26B of the support portion 26 can abut the front surface of the mullion 11 or a minor portion of the back surface 26B can abut the front surface of the mullion, as desired. For example, a portion of the back surface 26B of the support portion 26 of the mounting clip 12 may overhang an edge of the mullion 11 and thus not abut or contact a surface of the mullion 11.

With continued reference to FIGS. 4B and 4C, the clip portion 27 can include a mounting clip protrusion 28 that at least partially defines a mounting clip recess 29. For example, the mounting clip recess 29 is defined between the mounting clip protrusion 28 and the front surface 26A of the support portion 26. The clip portion 27 can be configured to mate with a housing clip portion of the window shade housing 14 such that the mounting clips 12 support the window shade housing 14. It should be appreciated, however that the clip portion 27 can have any configuration as desired so long as the clip portion 27 can support the window shade housing 14.

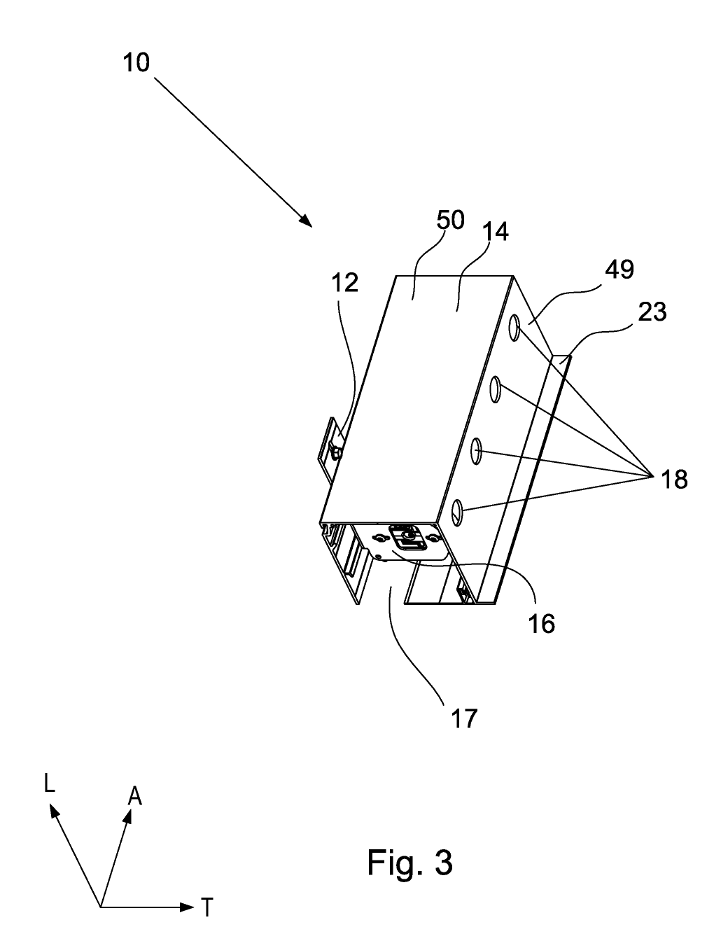

Now in reference to FIGS. 3, 4A, and 4B, the window shade housing 14 can be configured to be supported by the mounting clips 12 and can be further configured to house the roller shade assembly 16. As shown in FIGS. 3 and 4B, the window shade housing 14 is elongate along the second direction A and includes a back wall 48 that defines a front surface 48A and a back surface 48B. The window shade housing 14 can further include a front wall 49, a top wall 50 that extends between the front wall 49 and back wall 48, and a bottom wall 51 that extends from the front wall 49 and toward the back wall 48. As shown in FIG. 4A, the window shade housing 14 and in particular, the back wall 48, front wall 49, top wall 50, and bottom wall 51 at least partially defines an internal cavity 17 within which the roller shade assembly 16 can be housed. The window shade housing 14 can be made of any material as desired. For example, the window shade housing 14 can be made of a plastic material, a metal material, or some combination of materials.

As shown in FIGS. 3 and 4A, the window shade housing 14 can include a flange 23 that extends out from the window shade housing 14 along the third direction T, such that a drop ceiling tile (not shown) can rest on the flange 23. As well, the flange 23 can be elongate along the second direction A and can be continuous along the entire length of the window shade housing 14. It should be appreciated, however, that the flange 23 can be elongate for any length equal to or less than the length of the window shade housing 14 along the second direction A.

With continued reference to FIG. 3, the window shade housing 14 can also include venting apertures 18 that extend through the front wall 49 so as to allow heat, or solar gain, to flow above the ceiling line, or finished ceiling height. For example, the venting apertures 18 can include a minimum of four 1 inch (25.4 mm) diameter holes per foot allowing the solar gain to flow above the ceiling line. However, it should be appreciated that the venting apertures 18 can include any shape of any size that will allow the solar gain to flow above the ceiling line. It should also be appreciated that any number of venting apertures 18 can be defined and that the venting apertures 18 can extend through any wall of the window shade housing 14 as desired.

As shown in FIGS. 4B and 4D, the window shade housing 14 can further include at least one housing clip 30 that can be configured to mate with the mounting clips 12 to thereby mount the window shade housing 14 to the mullions 11, building structure, window frame, or vertical surface. The housing clip 30 can be elongate along the second direction A and can be recessed relative to the back surface 48B of the back wall 48 along the third direction T. The housing clip 30 can be continuous along a portion of the length of the window shade housing 14 such as along the entire length of the window shade housing 14 as illustrated. It should be appreciated, however, that the housing clip 30 can be interrupted along its length such that the window shade housing 14 has two or more housing clips 30.

As shown in FIG. 4D, the housing clip 30 can include an upper portion 33 and a housing clip protrusion 32 that extends down from the upper portion 33 substantially along the first direction L. The housing clip protrusion 32 and the upper portion 33 can define a housing clip recess 31 that is configured to receive the mounting clip protrusion 28. Therefore when the housing clip 30 is mated with the clip portions 27 of the mounting clips 12, the mounting clip protrusions 28 are received by the housing clip recess 31, and the housing clip protrusion is received by the mounting clip recesses 29.

Referring back to FIG. 4B, the back surfaces 26B of the support portions 26 of the mounting clips 12 can be coplanar with the back surface 48B of the back wall 48 of the window shade housing 14 when the window shade housing 14 is supported by the mounting clips 12. Therefore, when the at least one housing clip 30 is mated with the clip portions 27 of the mounting clips 12, the back surface 48B of the back wall 48 lies flush against the front surfaces of the mullions 11 along with the back surfaces 26B of the support portions 26. It should be appreciated that flush in this context means that at least a portion of the back surface 48B of the back wall 48 abuts at least a portion of the surfaces of at least some of the mullions 11. It should further be appreciated, that the housing clip 30 can have any configuration as desired so long as the window shade housing 14 can lie flush against the mullions when supported by the mounting clips 12.

With continued reference to FIG. 4B, the window shade housing 14 can also include at least one internal mounting member 35 that extends from the front surface 48A of the back wall 48 and into the internal cavity 17 along the third direction T. The internal mounting member 35 can be elongate along the second direction A and can be continuous along the entire length of the window shade housing 14. It should be appreciated, however, that the internal mounting member 35 can be elongate for any length equal to or less than the length of the window shade housing 14 along the second direction A. It should further be appreciated that the at least one internal mounting member can be two or more internal mounting members 35 that are spaced along the window shade housing 14. As shown in FIG. 4B, the internal mounting member 35 can be configured to support the roller shade assembly 16 within the internal cavity 17.

With continued reference to FIGS. 4B and 4D the internal mounting member 35 can include an internal mounting clip 36 that protrudes from the front surface 48A of the back wall 48 and an internal mounting tab 40 that protrudes from the front surface 48A of the back wall 48 such that the internal mounting tab 40 is spaced from the internal mounting clip 36 along the first direction L. The internal mounting clip 36 and the internal mounting tab 40 can be configured to support the roller shade assembly 16. As shown in FIG. 4D, the internal mounting clip 36 is configured as an angled protrusion that extends upward from the front surface 48A. Also shown in FIG. 4D, the internal mounting tab 40 includes a first protrusion 40A that extends out from the front surface 48A and a second protrusion 40B that extends down from an end of the first protrusion 40A so as to define a recess 40C. It should be appreciated, however, that the internal mounting member 35 can have any configuration as desired so long as the internal mounting member 35 can support the roller shade assembly 16.

Referring back to FIG. 4A the mounting brackets 34 can be supported by the internal mounting member 35 such that the roller tube 20 is disposed within the internal cavity 17. As previously mentioned, each roller shade assembly 16 of the window treatment system 10 can include the covering material 21, the roller tube 20 that windingly receives the covering material 21, and a motor operatively attached to the roller tube 20 so as to cause the roller tube 20 to rotate thereby moving the covering material 21 between the raised position and the lowered position along the first direction L. In the illustrated embodiment, the motor is disposed within the roller tube 20. It should be appreciated, however, that the window treatment system 10 can be devoid of a motor. It should also be appreciated that the window treatment system 10 can be configured to any type of shade system as desired. For example, the covering material 21 can be configured as a roller shade, a roman shade, venetian blinds, tensioned shades, and cable guided shades. It should further be appreciated that the window treatment system 10 can be a drapery system whereby the covering material 21 moves between an open position and a closed position along the second direction A. In similar fashion, the drapery system can include or be devoid of a motor.

Additionally, each roller shade assembly 16 can include first and second shade brackets 34 that are spaced from each other along the second direction A. The first and second shade brackets 34 can be attached to opposed ends of the roller tube 20 such that the roller tube 20 is rotatable relative to the first and second brackets. As shown in FIG. 4B, each bracket 34 includes a first mating member 60A and a second mating member 60B that is spaced from the first mating member 60A along the first direction L. The first mating members 60A of the first and second brackets 34 are configured to mate with the internal mounting clip 36 such that when mated the roller shade assembly 16 is supported by the window shade housing 14. As shown in FIG. 4B, when the roller shade assembly 16 is supported by the internal mounting clip 36 the second mating members 60B overlie the recess 40C defined by the internal mounting tab 40.

With continued reference to FIG. 4B, the roller shade assembly 16 can further include a respective fastener 42 that locks the first and second shade brackets to the window shade housing 14. In the illustrated embodiment, the fasteners 42 are threaded through the second mating members 60B and into the internal mounting tab 40 such as into the recess 40C defined by the internal mounting tab 40. It should be appreciated that the fasteners 42 can abut or be disjoined from the internal mounting member 35. It should also be appreciated that the fasteners 42 can abut the internal mounting tab 40 through any type of contact, such as by a distal end of the fastener 42 piercing partially or entirely through the surface of the internal mounting tab 40. It should further be appreciated that the first and second shade brackets can be mounted to the internal mounting member 35 using any structure as desired.

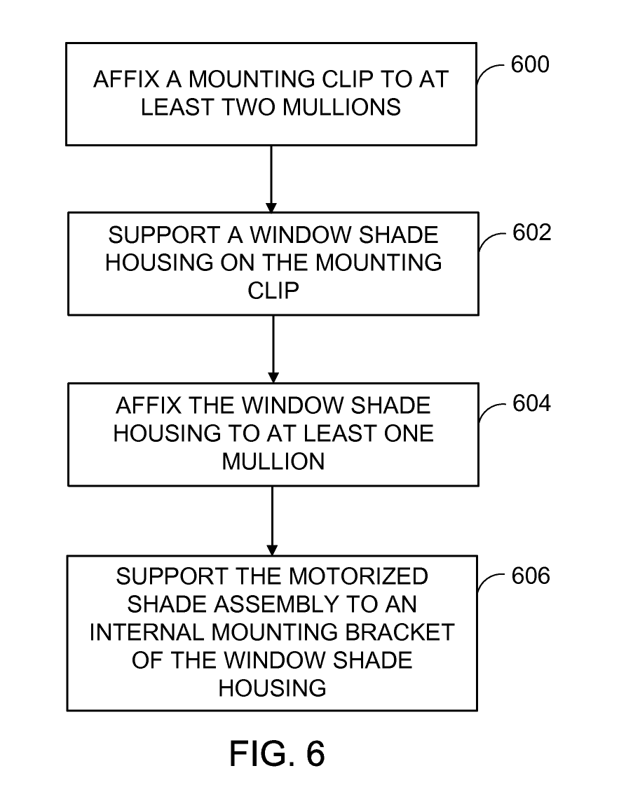

Now in reference to FIG. 6, the window treatment system 10 can be mounted or otherwise affixed to surfaces, e.g., a plurality of mullions 11, a building structure, a window frame, or a vertical surface. At step 600, at least two mounting clips 12 can be affixed to the surfaces. The mounting clips 12 can be loosely coupled to the respective surfaces by inserting a respective fixation element 24 through the slots 44 and into the surfaces. Each mounting clip 12 can then be moved relative to the fixation element 24 along the first direction L so that the mounting clips 12 can be aligned along the second direction A or otherwise leveled. Moving each mounting clip 12 along the first direction L such that the mounting clips 12 may be aligned along the second direction A may be referred to as “leveling.” It should be appreciated that the method may include leveling each respective mounting clip 12 with a laser level or any other device configured to detect level of an object with respect to another object, such as the level of two mounting clips 12 with respect to a ground surface. It should also be appreciated that the mounting clips 12 may be leveled with respect to each other or any other reference object. For example, the mounting clips 12 can be leveled using the scribe lines 46.

Once the mounting clips 12 are in their correct position, the fixation elements 24 can be tightened to thereby affix the mounting clips 12 to the respective surfaces such that the support portions 26 lie flush against the surfaces. It should be appreciated, that the fixation elements 24 can be tightened after the respective mounting clip 12 has been leveled. However, it should be appreciated that in some situations the fixation element 24 can be tightened without leveling the mounting clip 12.

At step 602, the window shade housing 14 can be supported on the mounting clips 12. In particular the window shade housing 14 can be supported by mating the at least one housing clip 30 of the window shade housing 14 with the clip portions 27 of the mounting clips 12 such that the back wall 48 and support portions 26 are coplanar. For example, when the at least one housing clip 30 is mated with the clip portions 27, the back wall 48 of the window shade housing 14 lies flush against the plurality of mullions 11. At step 604, the window shade housing 14 can be affixed to at least one mullion 11 of the plurality of mullions 11 with a fixation element 24. At step 606, the roller shade assembly 16 can be supported on the internal mounting member 35 of the window shade housing 14. In particular, the first and second shade brackets 34 can be mounted to the internal mounting member 35, such that the second shade bracket is spaced form the first shade bracket along the second direction A. For example, the first and second brackets 34 can be supported by the internal mounting bracket such that the first mating members 60A mate with the internal mounting clips 36 and the second mating members 60B overlie the recess 40C defined by the internal mounting tab 40.

Finally, the first and second shade brackets can be locked to the window shade housing 14 with respective fixation elements. For example, the first and second brackets can be locked to the window shade housing 14 by threading a fastener 42 through the second mating members 60B and into the recess 40C defined by the internal mounting tab 40.

While the foregoing description and drawings represent the preferred embodiment of the present invention, it will be understood that various additions, modifications, combinations and/or substitutions may be made therein without departing from the spirit and scope of the invention as defined in the accompanying claims. In particular, it will be clear to those skilled in the art that the invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components, which are particularly adapted to specific environments and operative requirements without departing from the principles of the invention. In addition, features or steps described herein may be used singularly or in combination with other features or steps. For example, features or steps described in connection with one component may be used and/or interchanged with features or steps described in another component or method. The presently disclosed embodiment is therefore to be considered in all respects as illustrative and not restrictive, the scope of the invention being indicated by the appended claims, and not limited to the foregoing description.

It will be appreciated by those skilled in the art that various modifications and alterations of the invention can be made without departing from the broad scope of the appended claims. Some of these have been discussed above and others will be apparent to those skilled in the art.

What is claimed:

1. A method of mounting a window treatment system, the method comprising the steps of:
affixing at least two mounting clips to respective vertical surfaces of a plurality of vertical surfaces, each vertical surface separating and supporting a respective pair of adjacent windows;
supporting a window treatment housing on the mounting clips, the window shade housing defining an internal cavity sized and configured to retain a window treatment assembly having a covering material configured to move between a raised position and a lowered position; and
affixing the window treatment housing to at least one vertical surface of the plurality of vertical surfaces with a fixation element.

2. The method of claim 1, wherein each mounting clip includes a support portion and a clip portion that extends out from the support portion, and the window treatment housing includes a back wall and at least one housing clip, and wherein the supporting step comprises mating the at least one housing clip with the clip portions such that the back wall and support portions are coplanar.

3. The method of claim 2, wherein the first affixing step comprises affixing the at least two mounting clips to the respective vertical surfaces such that the support portions lie flush against the at least two vertical surfaces, and the supporting step comprises mating the at least one housing clip with the clip portions such that the back wall lies flush against the plurality of vertical surfaces.

4. The method of claim 1, wherein each vertical surface is elongate along a first direction and each mounting clip includes a support portion that defines a slot that is elongate along the first direction, and wherein the first affixing step comprises the steps of:
loosely coupling each mounting clip to the respective vertical surfaces by inserting a respective fixation element through the slot and into the vertical surface;
moving each mounting clip relative to the respective fixation element along the first direction so that the mounting clips are aligned along a second direction that is perpendicular to the first direction; and
tightening the fixation elements to affix the mounting clips to the vertical surfaces.

5. The method of claim 1, wherein the vertical surfaces are elongate along a first direction and the window treatment housing includes at least one internal mounting member that is disposed within the internal cavity, and wherein the method further comprises the steps of:
mounting a first shade bracket of the motorized shade assembly to the internal mounting member; and
mounting a second shade bracket of the motorized shade assembly to the internal mounting member such that the second shade bracket is spaced from the first shade bracket along a second direction that is perpendicular to the first direction.

6. The method of claim 5, wherein the at least one internal mounting member is a single mounting member that is elongate along the second direction and wherein the mounting steps comprise mounting the first and second shade brackets to the single mounting member.

7. The method of claim 5, further comprising the step of locking the first and second shade brackets to the window treatment housing with respective fixation elements.

8. The method of claim 7, wherein the internal mounting member includes an internal mounting clip and an internal mounting tab spaced from the internal mounting clip along the first direction and wherein the locking step comprises threading a fastener through the second shade bracket and into the internal mounting tab.

9. The method of claim 5, further comprising a roller tube of the motorized shade assembly rotatably mounted to the first and second shade brackets, the covering material being windingly received about the roller tube and the motor being configured to rotate the roller tube.

10. The method of claim 1, further comprising the step of:
leveling each mounting clip with a laser level.

11. The method of claim 1, wherein the vertical surfaces are mullions that are elongate along a first direction, each mullion defining at least one opening that receives a respective window pane such that each mullion separates adjacent window panes from each other along a second direction that is perpendicular to the first direction.

12. A method of mounting a window treatment system, the method comprising the steps of:
affixing at least two mounting clips to respective vertical surfaces of a plurality of vertical surfaces, each vertical surface separating a respective pair of adjacent windows from each other, each mounting clip including a support portion and a clip portion that extends out from the support portion; and
supporting a window treatment housing from the clip portions of the mounting clips such that a back wall of the window treatment housing and the support portions are coplanar, the window treatment housing defining an internal cavity sized and configured to retain a window treatment assembly having a covering material configured to move between a raised position and a lowered position.

13. The method of claim 12, further comprising the step of affixing the window treatment housing to at least one vertical surface of the plurality of vertical surfaces with a respective fixation element.

14. The method of claim 12, wherein each vertical surface is elongate along a first direction and each support portion defines a slot that is elongate along the first direction, and wherein the affixing step comprises the steps of:
loosely coupling each mounting clip to the respective vertical surface by inserting a respective fixation element through the slot and into the vertical surface;
moving each mounting clip relative to the respective fixation element along the first direction so that the mounting clips are aligned along a second direction that is perpendicular to the first direction; and
tightening the fixation elements to affix the mounting clips to the vertical surfaces.

15. The method of claim 12, wherein the vertical surfaces are mullions that are elongate along a first direction, each mullion defining at least one opening that receives a respective window pane such that each mullion separates adjacent window panes from each other along a second direction that is perpendicular to the first direction.

16. A window treatment system configured to be mounted to a plurality of vertical surfaces that separate adjacent windows from each other, each vertical surface being elongate along a first direction, the window treatment system comprising:
at least two mounting clips configured to be mounted to respective vertical surfaces of the plurality of vertical surfaces, each mounting clip including a support portion and a clip portion that extends out from the support portion, each support portion defining a back surface;
a window treatment housing that is elongate along a second direction that is perpendicular to the first direction, the window shade housing including a back wall that defines a back surface and at least partially defines an internal cavity, the window shade housing further defining at least one housing clip that is recessed relative to the back surface of the back wall along a third direction that is perpendicular to the first and second directions, the at least one housing clip being configured to mate with the clip portions of the mounting clips to thereby mount the window shade housing to the vertical surfaces such that the back surfaces of the support portions are coplanar with the back surface of the back wall; and
a window treatment assembly configured to be mounted to the window treatment housing within the internal cavity, the window treatment assembly having a covering material configured to move between a raised position and a lowered position.

17. The window shade system of claim 16, wherein the housing clip is a single housing clip that is elongate along the second direction.

18. The window treatment system of claim 16, wherein the at least one housing clip includes a protrusion that extends substantially along the first direction, the protrusion being spaced from the back surface of the back wall along a third direction that is perpendicular to both the first and second directions, the protrusion further defining a recess that is configured to receive the clip portions.

19. The window treatment system of claim 18, wherein the clip portions each includes a protrusion that defines a recess, and wherein the protrusions of the clip portions are configured to be received by the recess of the at least one housing clip, and the recesses of the clip portions are configured to receive the protrusion of the at least one housing clip.

20. The window treatment system of claim 16, wherein the support portions each defines a slot that is elongate along the first direction, each slot being configured to receive a respective fixation element to thereby affix the mounting clips to the vertical surfaces.

21. The window treatment system of claim 16, wherein the window treatment housing further includes an internal mounting member that extends from the back wall and into the internal cavity, the internal mounting member being configured to support the window treatment assembly.

22. The window treatment system of claim 21, wherein the internal mounting member is elongate along the second direction.

23. The window treatment system of claim 21, wherein the internal mounting member includes an internal mounting clip that protrudes from the back wall and an internal mounting tab that protrudes from the back wall and is spaced from the internal mounting clip along the first direction.

24. The window treatment system of claim 23, wherein the window treatment assembly includes a first shade bracket configured to be supported by the internal mounting member and a second shade bracket configured to be supported by the internal mounting member such that the second shade bracket is spaced from the first shade bracket along the second direction.

25. The window treatment system of claim 24, wherein the window treatment assembly includes a roller tube that is configured to be rotatably attached to the first and second shade brackets, the covering material being windingly received about the roller tube and the motor being operatively attached to the roller tube so as to cause the roller tube to rotate.

26. The window treatment system of claim 30, further comprising a respective fastener that is configured to be inserted through the second shade bracket and into the internal mounting tab.

27. The window shade system of claim 16, wherein the window treatment assembly comprises a motorized shade assembly having a motor configured to move the covering material between the raised position and the lowered position.

28. The window shade system of claim 16, wherein the vertical surfaces are mullions, each mullion defining at least one opening that receives a respective window pane such that each mullion separates adjacent window panes from each other along a second direction that is perpendicular to the first direction.
